(19) United States
(12) Patent Application Publication
(10) Pub. No.: US 2017/0005318 A1
(43) Pub. Date: Jan. 5, 2017

(54) LAMINATED-TYPE BATTERY AND METHOD FOR MANUFACTURING THE SAME

(71) Applicant: NEC CORPORATION, Tokyo (JP)

(72) Inventor: Makihiro OTOHATA, Tokyo (JP)

(73) Assignee: NEC Corporation, Tokyo (JP)

(21) Appl. No.: 15/125,927

(22) PCT Filed: Mar. 25, 2015
(86) PCT No.: PCT/JP2015/059147

§ 371 Date: Sep. 13, 2016

(30) Foreign Application Priority Data
Mar. 25, 2014 (JP) 2014-061776

(51) Int. Cl. H01M 2/26; H01M 10/04; H01M 10/42; H01M 10/0525

(52) U.S. Cl. CPC H01M 2/266; H01M 10/0525; H01M 10/0413; H01M 10/0436; H01M 10/4235; H01G 11/66

(57) ABSTRACT

There is provided a laminated-type battery prevented from short-circuit between a positive electrode and a negative electrode, suppressed in a local increase in the thickness of the battery, and high in electric properties and the reliability. The laminated-type battery includes a battery element having at least two sheets of first-polarity electrodes each laminated with a second-polarity electrode with a separator therebetween, wherein the first-polarity electrode includes an electrode section having an active material layer formed on a current collector, a lead section having no active material layer formed on the current collector, and an insulating layer disposed over from the active material layer to an active material layer-non-formed region on a boundary region of the electrode section and the lead section, wherein the insulating layer of the one first-polarity electrode and the insulating layer of the another first-polarity electrode are formed at least partly on different positions as viewed in the lamination direction.

### TECHNICAL FIELD

The exemplary embodiment is related to a laminated-type battery and a method for manufacturing the same.

### BACKGROUND ART

Secondary batteries are broadly spread as power sources of portable devices such as cell phones, digital cameras and laptop computers, and further as power sources of vehicles and households. Among the secondary batteries, lithium ion secondary batteries having a high energy density and a light weight are energy accumulation devices indispensable to life.

Secondary batteries are roughly classified into wound-type ones and laminated-type ones. A battery element of a wound-type secondary battery has a structure in which a long positive electrode and a long negative electrode separated from each other by a separator and superposed are a plurality of times wound. A battery element of a laminated-type secondary battery has a structure in which a positive electrode and a negative electrode are separated from each other by a separator and alternately repeatedly laminated. The positive electrode and the negative electrode each have an active material layer-formed portion where an active material layer is formed on a current collector and an active material layer-non-formed portion where no active material layer is formed in order to provide a lead section. In either of a wound-type and a laminated-type secondary battery, one ends of the positive electrode lead section and the negative electrode lead section are electrically connected to the positive electrode active material layer-non-formed portion of the positive electrode and the negative electrode active material layer-non-formed portion of the negative electrode, respectively. The other ends of the positive electrode lead section and the negative electrode lead section are electrically connected to a positive electrode terminal and a negative electrode terminal, respectively. The battery element is sealed in an outer packaging container so that the positive electrode terminal and the negative electrode terminal can be led out to the outside. An electrolyte solution is sealed together with the battery element in the outer packaging container.

Secondary batteries are likely to have a larger capacity year by year. Therefore, if short-circuit is generated, there is a possibility that the secondary batteries more generate heat, and then it is important that the safety of the secondary batteries is improved. As a method of improving the safety of a secondary battery, for example, in order to prevent short-circuit between a positive electrode and a negative electrode, there is known a technique for forming an insulating layer on a boundary portion of an active material layer-formed portion and an active material layer-non-formed portion (Patent Literatures 1 and 2). On the other hand, Patent Literature 3 discloses a technology for lamination of current collector tabs.

### CITATION LIST

### Patent Literature

Patent Literature 1: JP2012-164470A

Patent Literature 2: JP2013-45795A

Patent Literature 3: JP2008-66170A

### SUMMARY OF INVENTION

### Technical Problem

In the case of using the technology disclosed in Patent Literatures 1 and 2, however, in a laminated secondary battery, the insulating layer is repeatedly laminated on the same position in plan view. Hence, the thickness of the battery element locally becomes large on the position where the insulating layers are disposed, reducing the energy density per volume.

Further in secondary batteries, for improving electric properties and the reliability, battery elements are fixed by a tape or the like and pressed under a uniform pressure. When an insulating layer as described in Patent Literatures 1 and 2 is provided in a laminated-type secondary battery, however, due to the difference in thickness between the portion where the insulating layer is laminated and the portion where no insulating layer is laminated, the battery element becomes unable to be pressed uniformly, bringing on the degradation of the quality of the battery including variations in electric properties and degradations in cycle characteristics in some cases.

The object of the exemplary embodiment is to provide a laminated-type battery prevented from short-circuit between a positive electrode and a negative electrode, suppressed in a local increase in the thickness of the battery, and high in electric properties and the reliability.

### Solution to Problem

A laminated-type battery according to the exemplary embodiment is one including a battery element having at least two sheets of first-polarity electrodes each laminated on a second-polarity electrode with a separator therebetween, wherein the first-polarity electrode includes an electrode section having an active material layer formed on a current collector, a lead section having no active material layer formed on the current collector, and an insulating layer disposed over from the active material layer to an active material layer-non-formed region on a boundary region of the electrode section and the lead section, wherein the insulating layer of the one first-polarity electrode and the insulating layer of the another first-polarity electrode are formed at least partly on different positions as viewed in the lamination direction.

Further a laminated-type battery according to the exemplary embodiment is one including a battery element having at least two sheets of first-polarity electrodes each laminated on a second-polarity electrode with a separator therebetween, wherein the first-polarity electrode includes an electrode section having an active material layer formed on a current collector, a lead section having no active material layer formed on the current collector, and an insulating layer disposed over from the active material layer to an active material layer-non-formed region on a boundary region of the electrode section and the lead section, wherein the insulating layer of the one first-polarity electrode and the insulating layer of the another first-polarity electrode are formed at least partly on different positions as viewed in the lamination direction, and wherein the formation of the insulating layers at least partly on the different positions reduces the thickness of laminated portions of the insulating layers.

A method for manufacturing a laminated-type battery according to the exemplary embodiment is one including forming an active material layer on a surface of a current collector to thereby obtain an electrode including an electrode section having the active material layer formed on the current collector and a lead section having no active material layer formed on the current collector, forming an insulating layer over from the active material layer to an active material layer-non-formed region on a boundary region of the electrode section and the lead section of the electrode to thereby obtain a first-polarity electrode, notching at least a part of a region of the first-polarity electrode where the insulating layer is formed to thereby form a notch portion, and laminating at least two sheets of the first-polarity electrodes each with a second-polarity electrode with a separator therebetween, wherein the insulating layer of the one first-polarity electrode and the insulating layer of the another first-polarity electrode are formed at least partly on different positions as viewed in the lamination direction.

### Advantageous Effects of Invention

According to the exemplary embodiment, there can be provided a laminated-type battery prevented from short-circuit between a positive electrode and a negative electrode, suppressed in a local increase in the thickness of the battery, and high in electric properties and the reliability.

### BRIEF DESCRIPTION OF DRAWINGS

FIG. 1 is a cross-sectional view illustrating one example of a constitution of a laminated-type lithium ion secondary battery according to the exemplary embodiment.

FIG. 2 is a top view illustrating one example of a positive electrode according to the exemplary embodiment.

FIG. 3 is a perspective exploded view illustrating one example of a battery element according to the exemplary embodiment.

FIG. 4 is a top view illustrating one example of a positive electrode according to the exemplary embodiment.

FIG. 5 is a perspective exploded view illustrating one example of a battery element according to the exemplary embodiment.

FIG. 6 is a top view illustrating one example of a positive electrode according to the exemplary embodiment.

FIG. 7 is a perspective exploded view illustrating one example of a battery element according to the exemplary embodiment.

FIG. 8 is a perspective exploded view illustrating one example of a battery element according to the exemplary embodiment.

FIG. 9 is a top view illustrating one example of a positive electrode according to the exemplary embodiment.

FIG. 10 is a perspective exploded view illustrating one example of a battery element according to the exemplary embodiment.

FIG. 11 is a top view illustrating one example of a positive electrode according to the exemplary embodiment.

FIG. 12 is a cross-sectional view illustrating laminated portions of insulating layers of a laminated-type battery.

### DESCRIPTION OF EMBODIMENT

[Laminated-Type Battery]

A laminated-type battery according to the exemplary embodiment is one including a battery element having at least two sheets of first-polarity electrodes each laminated on a second-polarity electrode with a separator therebetween, wherein the first-polarity electrode includes an electrode section having an active material layer formed on a current collector, a lead section having no active material layer formed on the current collector, and an insulating layer disposed over from the active material layer to an active material layer-non-formed region on a boundary region of the electrode section and the lead section, wherein the insulating layer of the one first-polarity electrode and the insulating layer of the another first-polarity electrode are formed at least partly on different positions as viewed in the lamination direction.

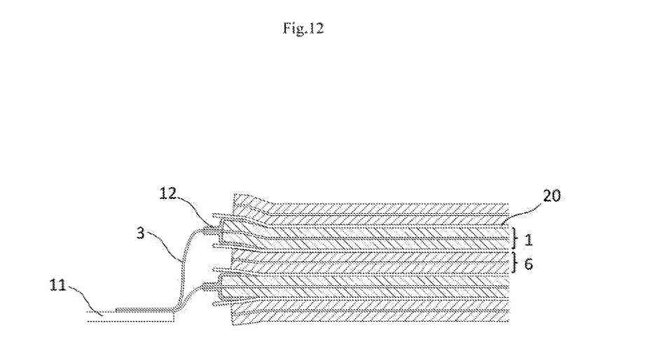

In the case where in order to prevent short-circuit between a positive electrode and a negative electrode, an insulating layer is provided on a boundary portion of an active material layer and an active material layer-non-formed region, the insulating layer needs to have a thickness in some measure to sufficiently exhibit the insulation effect, and as shown in FIG. 12, local increases in thickness thus occur in laminated portions of insulating layers 12. In the laminated-type battery according to the exemplary embodiment, an insulating layer of one first-polarity electrode and an insulating layer of another first-polarity electrode are formed at least partly on different positions as viewed in the lamination direction. That is, first-polarity electrodes are laminated so that at least parts of the insulating layers are not superposed as viewed in the lamination direction. In other words, first-polarity electrodes are laminated so that there are regions where the insulating layers are not superposed as viewed in the lamination direction. Thereby, a superposed portion in regions where the insulating layers are formed becomes small and the thickness of laminated portions of the insulating layers can be reduced. In the exemplary embodiment, since the short-circuit between a positive electrode and a negative electrode is prevented and a local increase in the thickness of a battery can be reduced, there can be obtained a laminated-type battery high in the electric properties and the reliability. Further since the local thickness of a battery is reduced, an outer packaging container having a uniform thickness can be used, improving the productivity. Further in the case where a plurality of batteries are laminated and installed, the height of the battery laminate can be made uniform. Particularly in the exemplary embodiment, it is preferable because the thickness of laminated portions of insulating layers can be more reduced that the insulating layer of a first-polarity electrode and the insulating layer of another first-polarity electrode be formed on different positions, that is, there is entirely no superposition of regions where the insulating layers are formed.

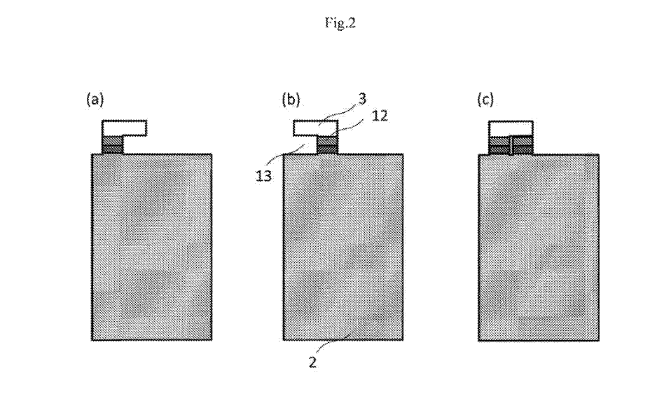

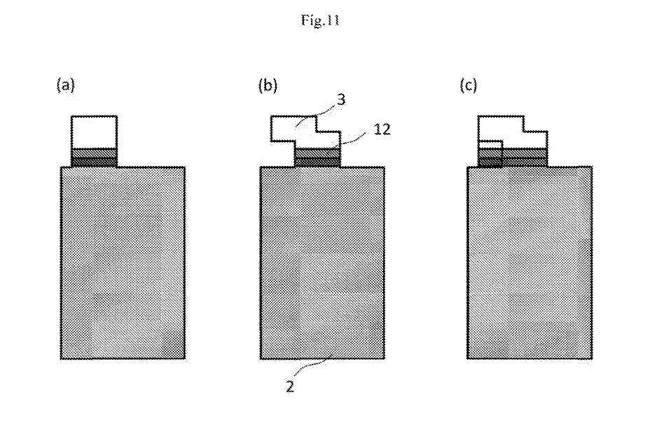

Methods of forming an insulating layer of one first-polarity electrode and an insulating layer of another first-polarity electrode at least partly on different positions as viewed in the lamination direction include, for example, as in FIG. 11 described later, a method involving shifting positions of insulating layers 12 as viewed in the lamination direction. Further, the exemplary embodiment encompasses, for example, as in FIGS. 2 to 10 described later, a laminated-type battery in which by providing notch portions 13 formed by notching the insulating layers 12, current collectors and as required, active material layers 2 in regions where the insulating layers 12 have been originally formed, the insulating layers 12 are made not to be superposed on the notch portions 13. That is, in this case, the notch portions correspond to regions where parts of the insulating layers are not superposed as viewed in the lamination direction.

Further in a case having three or more sheets of the first-polarity electrodes, laminated-type batteries are encompassed by the exemplary embodiment as long as at least a part of an insulating layer of at least one sheet of the first-polarity electrode thereof is not superposed on insulating layers of the other first-polarity electrodes. That is, for example, in the case having three sheets of the first-polarity electrodes, even if insulating layers of two sheets of the first-polarity electrodes are entirely superposed and take the same position, the laminated-type battery is encompassed by the exemplary embodiment in which at least a part of an insulating layer of the other one sheet of the first-polarity electrode is not superposed on the insulating layers of the above two sheets of the first-polarity electrodes, i.e., at least a part of the insulating layer is formed on a different position.

In the exemplary embodiment, it is preferable that in the first-polarity electrodes, the superposed width of regions where insulating layers are formed be small as compared with the superposed width of the ends of lead sections as viewed in the lamination direction. Examples of such a preferable case include forms as illustrated in FIGS. 2 to 8 and 10 described later. When the superposed width of regions where insulating layers are formed is small as compared with the superposed width of the ends of lead sections in the first-polarity electrodes, the first-polarity electrodes can be laminated so that at least parts of the insulating layers are easily on different positions. Here, the superposed width of the ends of the lead sections of the first-polarity electrodes indicates a width of the superposed portion of the ends of the lead sections of a plurality of sheets of the first-polarity electrodes as viewed in the lamination direction. In a case having three or more sheets of the first-polarity electrodes, the superposed width indicates a width of the superposed portion of the ends of the lead sections of all the first-polarity electrodes. Further the superposed width of regions where insulating layers are formed indicates a width of the portion where regions on a plurality of sheets of the first-polarity electrodes in which an insulating layer are formed are superposed. In a case having three or more sheets of the first-polarity electrodes, the superposed width indicates a width of the portion where regions on all the first-polarity electrodes in which an insulating layer is formed are superposed. Further in a case where superposed portions in regions where insulating layers are formed are separately present, the superposed width indicates a total of each width of the superposed portions. Further in a case where a superposed width of the region where insulating layers are formed is not constant, the longest width thereof is defined as the superposed width of regions where insulating layers are formed.

For example, in a case where insulating layers are formed on both surfaces of current collectors, when the superposed width of regions where the insulating layers are formed is small as compared with the superposed width of ends of the lead sections in the first-polarity electrodes as viewed in the lamination direction, there can be reduced thicknesses of one sheet of the first-polarity electrode by at least two layers of the insulating layers and one sheet of the current collector, in a portion where regions in which the insulating layers are formed are not superposed. Therefore, in the case where a battery element is fabricated by laminating the first-polarity electrodes, the thickness of laminated portions of insulating layers can be reduced.

It is preferable that the first-polarity electrode have a notch portion in at least a part of a region where the insulating layers are formed. Notch portions 13 can be provided, for example, as in FIGS. 2 to 10 described later. Here, the notch portion indicates a cut-out portion obtained by notching the insulating layer, the current collector and as required, the active material layer in at least a part of a region where the insulating layer is formed. When the first-polarity electrodes have the notch portions, there can easily be fabricated a state that at least parts of the insulating layers are on different positions as viewed in the lamination direction. Further thereby, there can easily be fabricated a state that the superposed width of regions where the insulating layers are formed is small as compared with the superposed width of the ends of the lead sections in the first-polarity electrodes as viewed in the lamination direction.

In the exemplary embodiment, for uniformly reducing the local increase in the thickness of a battery, it is preferable that the notch portions of the first-polarity electrodes have two or more shapes. Here, that the notch portions of the first-polarity electrodes have two or more shapes indicates that two or more sheets of the first-polarity electrodes have notch portions having two or more shapes. For example, in a case where two sheets of the first-polarity electrodes each have a notch portion, the two sheets of the first-polarity electrodes each have a notch portion of a shape different from each other. Further in a case where three sheets of the first-polarity electrodes each have a notch portion, the three sheets of the first-polarity electrodes may each have a notch portion of a shape different from one another, or two sheets of the first-polarity electrodes may each have a notch portion of the same shape and the other one sheet of the first-polarity electrode may have a notch portion of a shape different therefrom. Here, there is included the case where even if the shape itself of notch portions is the same, positions of the notch portions are different.

Particularly, because the thickness can be uniformly reduced by at least one layer of the insulating layer entirely in portions where insulating layers are laminated, it is preferable that in the case where all notch portions are superposed in the lamination direction of a battery element, the notch portions entirely cover active material layer-formed regions having insulating layers formed thereon before notching as viewed in the lamination direction. Here, the wording “in the case where all notch portions are superposed in the lamination direction of a battery element, the notch portions entirely cover active material layer-formed regions having insulating layers formed thereon before the notching as viewed in the lamination direction” indicates that the each notch portion is formed on the corresponding first-polarity electrode so that when all the notch portions formed on the first-polarity electrodes are superposed in lamination of the first-polarity electrodes, the notches entirely cover the active material layer-formed regions having insulating layers formed thereon before notching as viewed in the lamination direction.

Further, since portions where both the insulating layer and the active material layer are laminated increase the thickness of a battery by more than the thickness for the active material layer on lamination, it is preferable that the notch portions be provided at least in parts of regions where the insulating layer and the active material layer are formed.

The shape of the notch portion is not especially limited, and may be rectangular or circular. Further for reducing the resistance, it is preferable that the notch portion be not formed on a connection portion of a lead section with a terminal. The area of the notch portion per one sheet of the electrode depends on the number of types of shape of a notch portion provided in the each first-polarity electrode, but is preferably 20% or more and 70% or less to the area of a portion where the insulating layer is formed. It is preferable that the positions of the lead sections led out from current collectors be identical for every first-polarity electrode, because the lead sections can be connected to a terminal by being collected to one spot to thereby reduce the resistance, and also because the local thickness of a battery can be more reduced. The thickness of a laminated-type battery is not especially limited, but can be made to be, for example, 1 mm or more and 20 mm or less. Since the laminated-type battery according to the exemplary embodiment is reduced in the local thickness, the laminated-type battery may be used by laminating a plurality thereof.

In the exemplary embodiment, the first-polarity electrode may be a positive electrode or a negative electrode. Particularly in the case of a lithium ion secondary battery, however, the negative electrode is larger than the positive electrode and in order to prevent short-circuit between the positive electrode and the negative electrode, it is preferable that an insulating layer be formed on a boundary portion between a positive electrode active material layer and a positive electrode active material layer-non-formed region. Hence, it is preferable that the first-polarity electrode be a positive electrode and a second-polarity electrode be a negative electrode.

Further it is preferable that a battery element includes at least two sheets of second-polarity electrodes, wherein the second-polarity electrode includes an electrode section having an active material layer formed on a current collector, a lead section having no active material layer formed on the current collector, and an insulating layer disposed over from the active material layer to an active material layer-non-formed region on a boundary region of the electrode section and the lead section, wherein the insulating layer of the one second-polarity electrode and the insulating layer of the another second-polarity electrode be formed at least partly on different positions as viewed in the lamination direction. That is, it is preferable that the second-polarity electrode have the same constitution as the first-polarity electrode in the exemplary embodiment, and the second-polarity electrode be also provided with an insulating layer having the same constitution as that provided in the first-polarity electrode. In this case, the increase in the thickness can be reduced also in the laminated portions of the insulating layers of the second-polarity electrodes.

Hereinafter, the details of the exemplary embodiment will be described. Here, the exemplary embodiment described in the below is related to a laminated-type lithium ion secondary battery, but the exemplary embodiment is not limited to the laminated-type lithium ion secondary battery, and can be applied, for example, to battery elements of other kinds of chemical batteries such as a nickel hydrogen battery, a nickel cadmium battery, a lithium metal primary battery, a lithium metal secondary battery and a lithium polymer battery, further capacitor elements of lithium ion capacitors, condenser elements, and the like.

### First Exemplary Embodiment

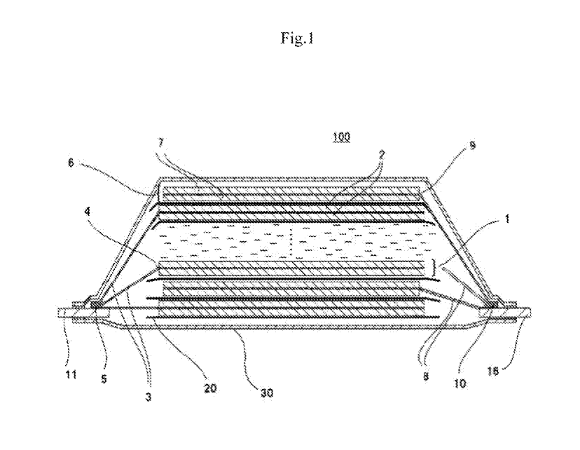

FIG. 1 illustrates a constitution of a laminated-type lithium ion secondary battery according to the present exemplary embodiment. The laminated-type lithium ion secondary battery 100 illustrated in FIG. 1 has a battery element in which a plurality of positive electrodes 1 and a plurality of negative electrodes 6 are alternately laminated with a separator 20 therebetween. The battery element, together with an electrolyte solution (not shown in figure), is accommodated in an outer packaging container 30 composed of a flexible film. The positive electrode 1 has a positive electrode current collector 4 and positive electrode active material layers 2. A positive electrode lead section 3 is led out from the positive electrode current collector 4 of the positive electrode 1, and the ends of the positive electrode lead sections 3 are connected to a positive electrode terminal 11 by being collected to one spot on a connection portion 5. Here, that the positive electrode lead section 3 is led out from the positive electrode current collector 4 involves that the positive electrode lead section 3 may be formed as a part of the positive electrode current collector 4, or a positive electrode lead section 3 being another member may be electrically connected to the positive electrode current collector 4. The end portion on the opposite side to the connection portion 5 of the positive electrode terminal 11 is led out to the outside of the outer packaging container 30. The negative electrode 6 has a negative electrode current collector 9 and a negative electrode active material layer 7. A negative electrode lead section 8 is led out from the negative electrode current collector 9 of the negative electrode 6, and the ends of the negative electrode lead sections 8 are connected to a negative electrode terminal 16 by being collected to one spot on a connection portion 10. The end portion on the opposite side to the connection portion 10 of the negative electrode terminal 16 is led out to the outside of the outer packaging container 30.

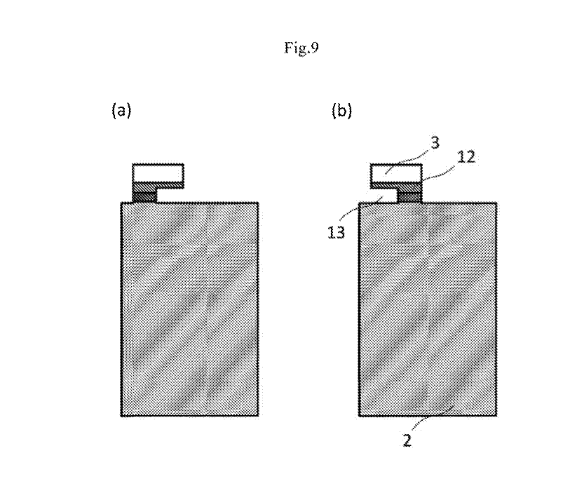

FIGS. 2(a) and 2(b) illustrate positive electrodes according to the present exemplary embodiment. The positive electrodes illustrated in FIGS. 2(a) and 2(b) are each provided with a positive electrode active material layer 2 on a positive electrode current collector, and a positive electrode lead section 3 is led out from a part of the positive electrode current collector. On a boundary of the positive electrode active material layer 2 and a positive electrode active material layer-non-formed region, there is provided an insulating layer 12 to prevent short-circuit between the positive electrode active material layer-non-formed region and a negative electrode. Further a part of the portion where the insulating layer 12 is provided is cut out and a notch portion 13 is provided. Positions where the notch portions 13 are provided are different between the positive electrode illustrated in FIG. 2(a) and the positive electrode illustrated in in FIG. 2(b). In the positive electrode illustrated in FIG. 2(a), the notch portion 13 is formed from one direction in a region where the insulating layer 12 is formed. In the positive electrode illustrated in FIG. 2(b), the notch portion 13 is formed from the other direction in the region where the insulating layer 12 is formed. In the present exemplary embodiment, since the notch portion 13 is formed from one direction in the region where the insulating layer 12 is formed, the notch portion 13 can easily be formed. In the case where two notch portions 13 are superposed in the lamination direction of a battery element, as illustrated in FIG. 2(c), the notch portions 13 are disposed so as to entirely cover positive electrode active material layer-formed regions where the insulating layers 12 have been formed before notching as viewed in the lamination direction. Here, the notch portions 13, as illustrated in FIGS. 9(a) and 9(b), may be provided so that a part of the positive electrode active material layer-non-formed region where the insulating layer 12 is formed is left.

The negative electrode according to the present exemplary embodiment is provided with a negative electrode active material layer on a negative electrode current collector, and a negative electrode lead section is led out from a part of the negative electrode current collector. In the present exemplary embodiment, no insulating layer nor notch portion are formed on the negative electrode, but an insulating layer and a notch portion similar to those of the positive electrode may be formed.

A material for the positive electrode current collector includes aluminum, stainless steel, nickel, titanium and alloys thereof. Among these, as a material for the positive electrode current collector, aluminum is preferable. As a material of the positive electrode lead section led out from the positive electrode current collector, the same material as in the positive electrode current collector can be used. In this case, for example, a positive electrode current collector having a positive electrode lead section can be obtained by being cut out from one sheet of a metal foil. The thickness of the positive electrode current collector is preferably 5 μm or more and 100 μm or less, and more preferably 10 μm or more and 50 μm or less.

A material for the negative electrode current collector includes copper, stainless steel, nickel, titanium and alloys thereof. Among these, as a material for the negative electrode current collector, copper is preferable. As a material for the negative electrode lead section led out from the negative electrode current collector, the same material as in the negative electrode current collector can be used. In this case, for example, a negative electrode current collector having a negative electrode lead section can be obtained by being cut out from one sheet of a metal foil. The thickness of the negative electrode current collector is preferably 5 μm or more and 100 μm or less, and more preferably 7 μm or more and 50 μm or less.

Examples of a positive electrode active material contained in the positive electrode active material layer include layer oxide-type materials such as LiCoO₂, LiNiO₂, LiNi₍₁₋ₓ₎CoₓO₂, LiNiₓ(CoAl)₍₁₋ₓ₎O₂, Li₂MO₃—LiMO₂ and LiNi_{1/3}Co_{1/3}Mn_{1/3}O₂, spinel-type materials such as LiMn₂O₄, LiMn_{1.5}Ni_{0.5}O₄ and LiMn₍₂₋ₓ₎MₓO₄, olivine-type materials such as LiMPO₄, fluorinated olivine-type materials such as Li₂MPO₄F and Li₂MSiO₄F, and vanadium oxide-type materials such as V₂O₅. These positive electrode active materials may be used singly or concurrently in two or more. The thickness of the positive electrode active material layer is preferably 10 μm or more and 200 μm or less, and more preferably 20 μm or more and 100 μm or less.

Examples of a negative electrode active material contained in the negative electrode active material layer include carbon materials such as graphite, amorphous carbon, diamond-like carbon, fullerene, carbon nanotubes and carbon nanohorns, alloy-type materials such as lithium metal materials, and of silicon or tin, and oxide-type materials such as Nb₂O₅ and TiO₂. These negative electrode active material may be used singly or concurrently in two or more. The thickness of the negative electrode active material layer is preferably 10 μm or more and 200 μm or less, and more preferably 20 μm or more and 100 μm or less.

The positive electrode active material layer and the negative electrode active material layer may further contain a conductive agent and a binder. The conductive agent includes carbon black, carbon fibers and graphite. These conductive agents may be used singly or concurrently in two or more. The binder includes polyvinylidene fluoride (PVdF), polytetrafluoroethylene, carboxymethylcellulose and modified acrylonitrile rubber particles. These binders may be used singly or concurrently in two or more.

The insulating layer is preferably at least one selected from the group consisting of adhesive tapes, heat fusing tapes and layers formed by coating and drying of a liquid containing an insulating material, because they can sufficiently prevent short-circuit between the positive electrode and the negative electrode. The adhesive tapes include tapes in which a resin layer of polyethylene, polypropylene or the like is used as a substrate and an adhesive layer is provided on one surface of the substrate. The heat fusing tapes include tapes in which a resin layer of polyethylene, polypropylene or the like is used as a substrate and which adhere by heat fusion. The insulating material includes polyimide, glass fibers, polyester and polypropylene. There may further be used mixtures of an inorganic particle of alumina, titania or the like with a binder such as polyvinylidene fluoride (PVdF), polytetrafluoroethylene, carboxymethylcellulose or modified acrylonitrile rubber particles. These may be used singly or concurrently in two or more. A solvent to disperse or dissolve the insulating material is not especially limited as long as being a solvent capable of being removed by drying. The thickness of the insulating layer is preferably 1 μm or more and 200 μm or less, and more preferably 10 μm or more and 100 μm or less. When the thickness of the insulating layer is 1 μm or more, short-circuit between the positive electrode and the negative electrode can sufficiently be prevented and the advantage of the present exemplary embodiment can sufficiently be attained. Further when the thickness of the insulating layer is 200 μm or less, the local thickness of a battery can be reduced. The width of the insulating layer is not especially limited as long as being capable of cover the boundary portion of the positive electrode active material layer and the positive electrode active material layer-non-formed region. However, for preventing short-circuit due to mingling of metal materials between the positive electrode active material layer-non-formed region and a negative electrode facing it, it is preferable that a portion facing the negative electrode of the positive electrode active material layer-non-formed region and a portion including a positive electrode active material layer-formed region adjacent thereto be covered by the insulating layer in a width of 0.5 mm or more and 10 mm or less.

As an electrolyte solution, there can be used a solution in which a lithium salt as an electrolyte is dissolved in a solvent. Examples of the solvent include cyclic carbonates such as ethylene carbonate, propylene carbonate, vinylene carbonate and butylene carbonate, linear carbonates such as ethyl methyl carbonate (EMC), diethyl carbonate (DEC), dimethyl carbonate (DMC) and dipropyl carbonate (DPC), aliphatic carboxylate esters, γ-lactones such as γ-butyrolactone, linear ethers, and cyclic ethers. These solvents may be used singly or concurrently in two or more. Examples of the lithium salt include LiPF₆, LiAsF₆, LiAlCl₄, LiClO₄, LiBF₄, LiSbF₆, LiCF₃SO₃, LiC₄F₉CO₃, LiC(CF₃SO₂)₂, LiN(CF₃SO₂)₂, LiN(C₂F₅SO₂)₂, LiB₁₀Cl₁₀, lithium lower aliphatic carboxylates, chloroboranelithium, lithium tetraphenylborate, LiBr, LiI, LiSCN, LiCl, and imides. These lithium salts may be used singly or concurrently in two or more.

The separator includes porous membranes, woven fabrics and nonwoven fabrics. Examples of a material for the separator include polyolefin resins such as polypropylene and polyethylene, polyester resins, acryl resins, styrene resins and nylon resins. These materials may be used singly or concurrently in two or more. As the separator, a porous membrane of a polyolefin resin is preferable because it is excellent in the performance of ion permeability and physically separating the positive electrode and the negative electrode. Further as required, the separator may have a layer containing inorganic substance particles. The inorganic substance particles include particles of insulative oxides, nitrides, sulfides, carbides and the like. As the inorganic substance particle, particles of TiO₂ or Al₂O₃ are preferable. These inorganic substance particles may be used singly or concurrently in two or more.

The outer packaging container includes cases of flexible film and can cases. Among these, cases of flexible film are preferable as the outer packaging container for the weight reduction of a laminated-type battery. Examples of the flexible film include films of a metal layer being a substrate provided with a resin layer on at least one surface thereof. As a material of the metal layer, there can suitably be selected a material having the barrier property capable of preventing the bleedout of an electrolyte solution and the intrusion of moisture from the outside. Examples of the material include aluminum and stainless steel. These materials may be used singly or concurrently in two or more. Examples of the resin layer disposed on the inside of the outer packaging container include heat fusing resin layers containing a modified polyolefin and the like. In the case where the resin layer is a heat fusing resin layer, by making the heat fusing resin layers of two sheets of flexible film to face each other and heat fusing the circumferences of portions where a battery element is accommodated, the outer packaging container can be formed. The resin layer disposed on the outside of the outer packaging container includes layers of nylon film, polyester film or the like. Since a battery according to the present exemplary embodiment is reduced in the local thickness, an outer packaging container having a uniform thickness can be used.

A material of the positive electrode terminal includes aluminum and aluminum alloys. A material of the negative electrode terminal includes copper and copper alloys. Further the negative electrode terminal may be plated with nickel. The positive electrode lead sections can be connected to the positive electrode terminal by being collected on one spot by ultrasonic welding or the like. By connecting the positive electrode lead sections to the positive electrode terminal by being collected on one spot, the resistance can be reduced and battery properties are improved. The similarity applies also to the negative electrode lead sections and the negative electrode terminal. The positive electrode terminal and the negative electrode terminal are led out to the outside of the outer packaging container. In the case where the outer packaging container is sealed by heat fusion, a heat fusing resin may be provided previously on heat fusing portions of the outer packaging container for the positive electrode terminal and the negative electrode terminal.

### Second Exemplary Embodiment

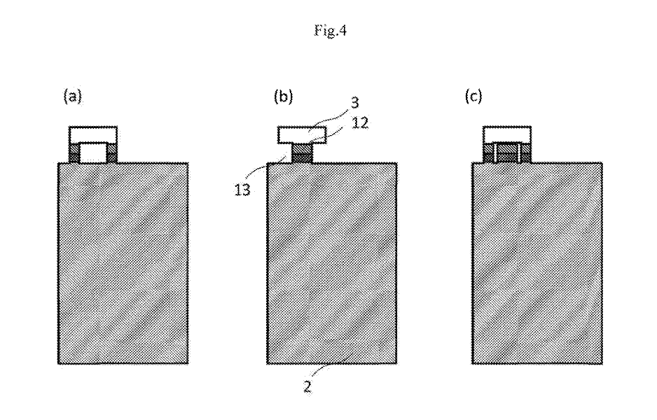

The present exemplary embodiment is the same as the first exemplary embodiment except for using positive electrodes illustrated in FIGS. 4(a) and 4(b). The positive electrode illustrated in FIG. 4(a) has a notch portion 13 as a hole formed in a central portion of a region where an insulating layer 12 is formed. The positive electrode illustrated in FIG. 4(b) has a notch portion 13 formed vertically symmetrically from both directions in a region where an insulating layer 12 is formed. In the case where the two notch portions 13 are superposed in the lamination direction of a battery element, as illustrated in FIG. 4(c), the notch portions 13 are disposed so as to entirely cover positive electrode active material layer-formed regions having the insulating layers 12 formed thereon before notching as viewed in the lamination direction. In the present exemplary embodiment, since the notch portion 13 is formed vertically symmetrically in the region where the insulating layer 12 is formed, the strength of a positive electrode lead section 3 is improved.

### Third Exemplary Embodiment

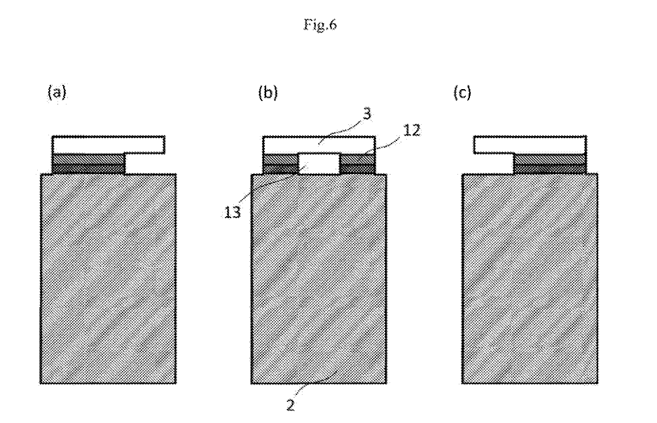

The present exemplary embodiment is the same as the first exemplary embodiment except for using positive electrodes illustrated in FIGS. 6(a) to 6(c). Positive electrode lead sections 3 of the positive electrodes illustrated in FIGS. 6(a) to 6(c) have larger widths than the positive electrode lead sections of the positive electrodes according to the first exemplary embodiment. The positive electrode illustrated in FIG. 6(a) has a notch portion 13 formed from one direction in a region where an insulating layer 12 is formed. The positive electrode illustrated in FIG. 6(c) has a notch portion 13 formed from the other direction in a region where an insulating layer 12 is formed. The positive electrode illustrated in FIG. 6(b) has a notch portion 13 as a hole formed in a central portion in a region where an insulating layer 12 is formed. In the case where the three notch portions 13 are superposed in the lamination direction of a battery element, the notch portions 13 are disposed so as to entirely cover positive electrode active material layer-formed regions having the insulating layers 12 formed thereon before notching as viewed in the lamination direction. In the present exemplary embodiment, since the three sheets of the positive electrodes have notch portions 13 having different shapes formed, and the respective notch portions 13 are disposed on different positions in the lamination direction, the width of the notch portion 13 formed in one sheet of the positive electrode can be made narrow and the strength of the positive electrode lead section 3 is improved.

### Fourth Exemplary Embodiment

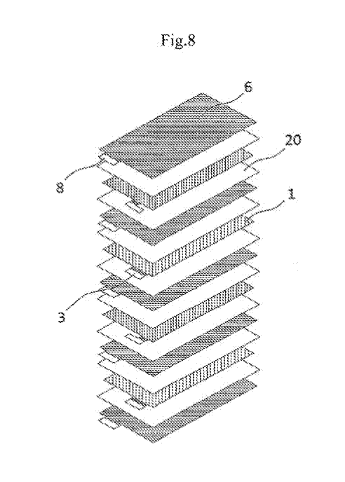

The present exemplary embodiment is the same as the first exemplary embodiment, as illustrated in FIG. 8, except for fabricating a battery element by further using two sheets of positive electrodes 1 provided with no notch portion. By concurrently using positive electrodes 1 provided with no notch portion, the number of electrodes laminated of a battery element can easily be increased and the battery performance can be improved. In the case where positive electrodes provided with no notch portion are used as in the present exemplary embodiment, it is preferable that the total of reductions in electrode thickness due to notch portions be larger than the total of increases in thickness due to insulating layers.

### Fifth Exemplary Embodiment

The present exemplary embodiment is the same as the first exemplary embodiment, as illustrated in FIG. 9, except for not notching parts of positive electrode active material layer-non-formed regions having an insulating layer formed thereon. In the case where the thickness of a positive electrode active material layer is larger than the thickness of the insulating layer, since the thickness of the insulating layer on the positive electrode active material layer-non-formed region does not make a cause of the local increase in thickness of a battery, the insulating layer on the positive electrode active material layer-non-formed region is allowed to be excluded from the notching region.

### Sixth Exemplary Embodiment

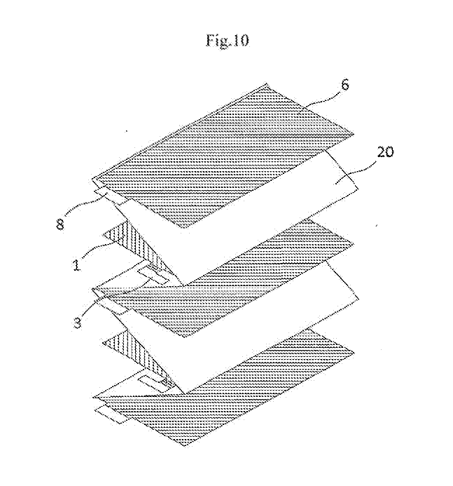

The present exemplary embodiment is the same as the first exemplary embodiment, as illustrated in FIG. 10, except for using a long separator 20 and fabricating a battery element such that the separator 20 is folded while alternately interposing a positive electrode 1 and a negative electrode 6 therebetween. By using the long separator 20 by being folded zigzag, the lamination structure of the positive electrode 1, the negative electrode 6 and the separator 20 can easily be maintained and the fabrication of the battery element and the accommodation of the battery element in an outer packaging container can be made easy. Further a battery element may be fabricated by using a long negative electrode and fabricating the battery element such that the negative electrode is folded while alternately interposing a positive electrode and a separator therebetween.

### Seventh Exemplary Embodiment

In the present exemplary embodiment, as illustrated in FIG. 11, regions where insulating layers of two sheets of positive electrodes are formed are partly superposed as viewed in the lamination direction, and the ends of positive electrode lead sections 3 are entirely superposed as viewed in the lamination direction. The present exemplary embodiment is the same as the first exemplary embodiment except for fabricating the positive electrodes of such shapes as in the first exemplary embodiment. In the present exemplary embodiment, although no notch portions are provided in the regions where the insulating layers of the positive electrodes are formed, since the regions where the insulating layers of two sheets of the positive electrodes are formed are disposed so as to be shifted from each other on lamination, the superposed width of the regions where the insulating layers are formed is small as compared with the superposed width of the ends of lead sections of the two sheets of the positive electrodes. In the present exemplary embodiment, the thickness of laminated portions of the insulating layers can be reduced without notching the regions where the insulating layers are formed. Although in the present exemplary embodiment, regions where insulating layers of two sheets of positive electrodes are formed are partly superposed as viewed in the lamination direction, the regions may be made not to be superposed as viewed in the lamination direction.

[Method for Manufacturing a Laminated-Type Battery]

A method for manufacturing a laminated-type battery according to the exemplary embodiment is one including forming an active material layer on a surface of a current collector to thereby obtain an electrode including an electrode section having the active material layer formed on the current collector and a lead section having no active material layer formed on the current collector, forming an insulating layer over from the active material layer to an active material layer-non-formed region on a boundary region of the electrode section and the lead section of the electrode to thereby obtain a first-polarity electrode, notching at least a part of the region of the first-polarity electrode having the insulating layer formed thereon to thereby form a notch portion, and laminating at least two sheets of the first-polarity electrodes with a second-polarity electrode with a separator therebetween, wherein the insulating layer of the one first-polarity electrode and the insulating layer of the another first-polarity electrode are formed at least partly on different positions as viewed in the lamination direction. According to the method, the laminated-type battery according to the exemplary embodiment can easily be manufactured.

(Electrode Fabrication Step)

The present step forms an active material layer on a surface of a current collector to thereby obtain an electrode. A current collector having a portion to become a lead section can be fabricated by cutting-out from one sheet of a metal foil. Further a current collector having a portion to become a lead section may be fabricated by connecting a portion to become a lead section to the current collector. The active material layer can be formed, for example, by coating and drying a solution in which an active material, a conductive agent and a binder are dispersed in a solvent such as N-methylpyrrolidone, on the current collector. The active material layer may be formed on one surface of the current collector or on both surfaces thereof.

(Insulating Layer Formation Step)

The present step forms an insulating layer over from the active material layer to an active material layer-non-formed region on a boundary region of the electrode section and the lead section. Thereby, a first-polarity electrode is obtained. In the case where a tape such as an adhesive tape or a heat fusing tape is used as the insulating layer, the insulating layer can be formed by sticking the tape. Further the insulating layer may be formed by applying and drying a liquid in which an insulating material is dispersed or dissolved in a solvent.

(Notch Portion Formation Step)

The present step forms a notch portion by notching at least a part of a region where the insulating layer is formed. The notch portion can be formed, for example, by blanking. Alternatively, a current collector having no portion to become a lead section is used in fabrication of an electrode, and the lead section may be formed simultaneously with a notch portion in blanking. It is preferable that the formation of the notch portion be carried out so that the active material layer and the current collector are not exposed in the cross-section of the notched portion. Alternatively, a notch portion is formed on an electrode having a lead section, and thereafter, an insulating layer may be formed.

(Battery Element Fabrication Step)

The present step laminates at least two sheets of the first-polarity electrodes with a second-polarity electrode with a separator therebetween to thereby obtain a battery element. Alternatively, as in the sixth exemplary embodiment, a battery element may be fabricated by using a long negative electrode and fabricating the battery element such that the negative electrode is folded while alternately interposing a positive electrode and a separator therebetween. Alternatively, a battery element may be fabricated by using a long separator and fabricating the battery element such that the separator is folded while alternately interposing a positive electrode and a negative electrode therebetween.

For example, in the case where a laminated-type lithium ion secondary battery is fabricated, thereafter by connecting the each lead section to a terminal by collecting the lead sections on one spot and accommodating the battery element and the electrolyte solution in an outer packaging container, a laminated-type lithium ion secondary battery according to the exemplary embodiment can be obtained.

### EXAMPLES

Hereinafter, specific examples of the exemplary embodiment will be described, but the exemplary embodiment is not limited thereto.

### Example 1

(Fabrication of Positive Electrodes)

Positive electrodes having shapes illustrated in FIGS. 2(a) and 2(b) were fabricated. First, there were prepared a mixture of LiMn₂O₄ and LiNi_{0.8}Co_{0.1}Al_{0.1}O₂ as a positive electrode active material, a carbon black as a conductive agent and a PVdF as a binder. A mixture of these was dispersed in N-methylpyrrolidone to thereby obtain a slurry. The slurry was applied and dried on both surfaces of each of two sheets of positive electrode current collectors having aluminum of 20 μm in thickness as a main component to thereby form positive electrode active material layers 2 of 80 μm in thickness. Thereafter, over from the positive electrode active material layer to a positive electrode active material layer-non-formed portion on a boundary region of a positive electrode section and a positive electrode lead section 3, there was stuck as an insulating layer 12 a propylene-made adhesive tape of 10 mm in width and 30 μm in thickness. Further as illustrated in FIGS. 2(a) and 2(b) each, a part of a region where the insulating layer 12 was formed was notched by blanking to thereby form a notch portion 13. The shapes of the obtained positive electrodes illustrated in FIGS. 2(a) and 2(b) were, in the case where all the notch portions 13 were superposed in the lamination direction of the battery element, as illustrated in FIG. 2(c), shapes entirely covering positive electrode active material layer-formed regions having the insulating layers 12 formed before notching as viewed in the lamination direction.

(Fabrication of Negative Electrodes)

There were prepared a graphite covered with an amorphous carbon on the surface thereof as a negative electrode active material, and a PVdF as a binder. A mixture of these was dispersed in N-methylpyrrolidone to thereby obtain a slurry. The slurry was applied and dried on both surfaces of a copper foil of 15 μm in thickness as a negative electrode current collector to thereby form negative electrode active material layers of 55 μm in thickness. Thereby, three sheets of negative electrodes each having a negative electrode lead section were obtained.

(Fabrication of a Laminated-Type Lithium Ion Secondary Battery)

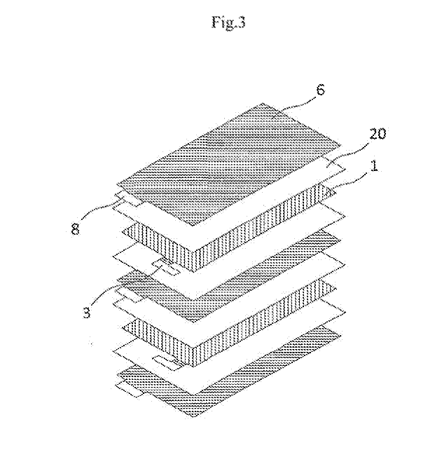

As illustrated in FIG. 3, a battery element was obtained by alternately laminating two sheets of the obtained positive electrodes 1 and three sheets of the obtained negative electrodes 6 through a polypropylene-made separator 20 of 25 μm in thickness. Each positive electrode lead section 3 was connected to a positive electrode lead terminal by being collected on one spot thereon. Further each negative electrode lead section 8 was connected to a negative electrode lead terminal by being collected on one spot thereon. As illustrated in FIG. 1, the battery element, together with an electrolyte solution, was accommodated in an outer packaging container 30 composed of a flexible film to thereby obtain a laminated-type lithium ion secondary battery of 8 mm in thickness. Since the secondary battery had the insulating layers formed, short-circuit between the positive electrode active material layer-non-formed regions and the negative electrodes was prevented. Further due to the presence of the notch portions, since there was no superposition of the regions where the insulating layers were formed and the increase in the thickness in laminated portions of the insulating layers was suppressed, there was obtained a secondary battery high in electric properties and the reliability.

### Example 2

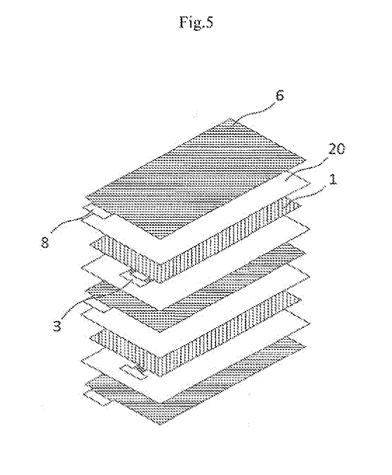

Positive electrodes having shapes illustrated in FIGS. 4(a) and 4(b) were fabricated as in Example 1. The shapes of the positive electrodes illustrated in FIGS. 4(a) and 4(b) were, in the case where all the notch portions 13 were superposed in the lamination direction of a battery element, as illustrated in FIG. 4(c), shapes entirely covering positive electrode active material layer-formed regions having the insulating layers 12 formed before notching as viewed in the lamination direction. A laminated-type lithium ion secondary battery was fabricated as in Example 1 except for using these positive electrodes. Here, the constitution of the battery element in the present Example is illustrated in FIG. 5. Since the secondary battery had the insulating layers formed, short-circuit between the positive electrode active material layer-non-formed regions and the negative electrodes was prevented. Further due to the presence of the notch portions, since there was no superposition of the regions where the insulating layers were formed and the increase in the thickness in laminated portions of the insulating layers was suppressed, there was obtained a secondary battery high in electric properties and the reliability.

### Example 3

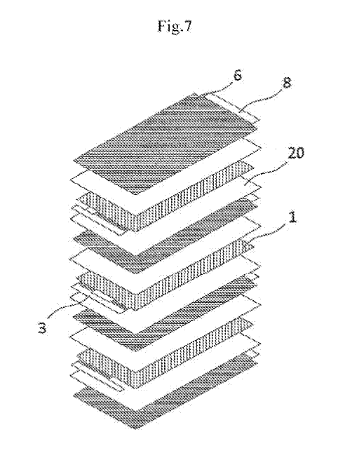

Positive electrodes having shapes illustrated in FIGS. 6(a) to 6(c) were fabricated as in Example 1. The shapes of the positive electrodes illustrated in FIGS. 6(a) to 6(c) were, in the case where all the notch portions 13 were superposed in the lamination direction of a battery element, shapes entirely covering positive electrode active material layer-formed regions having the insulating layers 12 formed before notching as viewed in the lamination direction. Further four sheets of negative electrodes were fabricated as in Example 1. A laminated-type lithium ion secondary battery was fabricated as in Example 1 except for obtaining the battery element by alternately laminating the three sheets of the obtained positive electrodes 1 and four sheets of the obtained negative electrodes 6 through a polypropylene-made separator 20 of 25 μm in thickness as illustrated in FIG. 7. Since the secondary battery had the insulating layers formed, short-circuit between the positive electrode active material layer-non-formed regions and the negative electrodes was prevented. Further due to the presence of the notch portions, since there was no region where the insulating layers of the three sheets of the positive electrodes were entirely superposed and the increase in the thickness in laminated portions of the insulating layers was suppressed, there was obtained a secondary battery high in electric properties and the reliability.

### Example 4

Positive electrodes having shapes illustrated in FIGS. 2(a) and 2(b) were fabricated as in Example 1. Further two sheets of positive electrodes were fabricated as in Example 1 except for being provided with no notch portion. Further five sheets of negative electrodes were fabricated as in Example 1. A laminated-type lithium ion secondary battery was fabricated as in Example 1 except for obtaining the battery element by alternately laminating the four sheets of the obtained positive electrodes 1 and the five sheets of the obtained negative electrodes 6 through a polypropylene-made separator 20 of 25 μm in thickness as illustrated in FIG. 8. Since the secondary battery had the insulating layers formed, short-circuit between the positive electrode active material layer-non-formed regions and the negative electrodes was prevented. Further due to the presence of the notch portions, since there was no region where the insulating layers of the four sheets of the positive electrodes 1 were entirely superposed and the increase in the thickness in laminated portions of the insulating layers was suppressed, there was obtained a secondary battery high in electric properties and the reliability.

### Example 5

Positive electrodes were fabricated as in Example 1 except for using a polypropylene-made heat fusing tape of 10 mm in width and 30 μm in thickness as the insulating layer. Then, a laminated-type lithium ion secondary battery was fabricated as in Example 1 except for using these positive electrodes. Since the secondary battery had the insulating layers formed, short-circuit between the positive electrode active material layer-non-formed regions and the negative electrodes was prevented. Further due to the presence of the notch portions, since there was no superposition of regions where the insulating layers were formed and the increase in the thickness in laminated portions of the insulating layers was suppressed, there was obtained a secondary battery high in electric properties and the reliability.

### Example 6

A solution obtained by dispersing an alumina as an insulating material and a PVdF as a binder in N-methylpyrrolidone was applied and dried over from a positive electrode active material layer to a positive electrode active material layer-non-formed portion on a boundary region of a positive electrode section and a positive electrode lead section 3 to thereby form an insulating layer of 10 mm in width and 20 μm in thickness. Except for this, positive electrodes were fabricated as in Example 1. Then, a laminated-type lithium ion secondary battery was fabricated as in Example 1 except for using these positive electrodes. Since the secondary battery had the insulating layers formed, short-circuit between the positive electrode active material layer-non-formed regions and the negative electrodes was prevented. Further due to the presence of the notch portions, since there was no superposition of regions where the insulating layers were formed and the increase in the thickness in laminated portions of the insulating layers was suppressed, there was obtained a secondary battery high in electric properties and the reliability.

### Example 7

Positive electrodes were fabricated as in Example 1 except for not notching parts of positive electrode active material layer-non-formed regions having an insulating layer formed thereon as illustrated in FIG. 9. Then, a laminated-type lithium ion secondary battery was fabricated as in Example 1 except for using these positive electrodes. Since the secondary battery had the insulating layers formed, short-circuit between the positive electrode active material layer-non-formed regions and the negative electrodes was prevented. Further due to the presence of the notch portions, since superposed portions in regions where the insulating layers were formed became small and the increase in the thickness in laminated portions of the insulating layers was suppressed, there was obtained a secondary battery high in electric properties and the reliability.

### Example 8

A battery element was obtained by using a polypropylene-made long separator 20 of 25 μm in thickness, and fabricating the battery element such that the separator 20 was folded while alternately interposing a positive electrode 1 and a negative electrode 6 therebetween as illustrated in FIG. 10. A laminated-type lithium ion secondary battery was fabricated as in Example 1 except for using this battery element. Since the secondary battery had the insulating layers formed, short-circuit between the positive electrode active material layer-non-formed regions and the negative electrodes was prevented. Further due to the presence of the notch portions, since there was no superposition of regions where the insulating layers were formed and the increase in the thickness in laminated portions of the insulating layers was suppressed, there was obtained a secondary battery high in electric properties and the reliability.

### Example 9

Positive electrodes were fabricated as in Example 1 except for making regions where insulating layers of two sheets of positive electrodes were formed to be partly superposed as viewed in the lamination direction, and making the ends of positive electrode lead sections 3 to be entirely superposed as viewed in the lamination direction as illustrated in FIG. 11. Further a laminated-type lithium ion secondary battery was fabricated as in Example 1 except for using these positive electrodes. Since the secondary battery had the insulating layers formed, short-circuit between the positive electrode active material layer-non-formed regions and the negative electrodes was prevented. Further since the regions where the insulating layers of two sheets of the positive electrodes were formed were disposed so as to be shifted from each other in lamination, the superposed width of the regions where the insulating layers were formed was small as compared with the superposed width of the ends of lead sections of the two sheets of the positive electrodes, and the increase in the thickness in laminated portions of the insulating layers was suppressed; thus, there was obtained a secondary battery high in electric properties and the reliability.

The present application claims priority based on Japanese Patent Application No. 2014-61776, filed on Mar. 25, 2014, the entire disclosure of which is hereby incorporated.

Hitherto, the present invention has been described by reference to the exemplary embodiments and the Examples, but the present invention is not limited to the above exemplary embodiments and Examples. Various changes and modifications understandable to those skilled in the art may be made on the constitution and details of the present invention within the scope of the present invention.

### REFERENCE SIGNS LIST

1 POSITIVE ELECTRODE

2 POSITIVE ELECTRODE ACTIVE MATERIAL LAYER

3 POSITIVE ELECTRODE LEAD SECTION

4 POSITIVE ELECTRODE CURRENT COLLECTOR

5 CONNECTION PORTION

6 NEGATIVE ELECTRODE

7 NEGATIVE ELECTRODE ACTIVE MATERIAL LAYER

8 NEGATIVE ELECTRODE LEAD SECTION

9 NEGATIVE ELECTRODE CURRENT COLLECTOR

10 CONNECTION PORTION

11 POSITIVE ELECTRODE TERMINAL

12 INSULATING LAYER

13 NOTCH PORTION

16 NEGATIVE ELECTRODE TERMINAL

20 SEPARATOR

30 OUTER PACKAGING CONTAINER

100 LAMINATED-TYPE LITHIUM ION SECONDARY BATTERY

1. A laminated-type battery, comprising a battery element having at least two sheets of first-polarity electrodes each laminated with a second-polarity electrode with a separator therebetween,
wherein the first-polarity electrode comprises: an electrode section having an active material layer formed on a current collector; a lead section having no active material layer formed on the current collector; and an insulating layer disposed over from the active material layer to an active material layer-non-formed region on a boundary region of the electrode section and the lead section,
wherein the insulating layer of the one first-polarity electrode and the insulating layer of the another first-polarity electrode are formed at least partly on different positions as viewed in the lamination direction.

2. The laminated-type battery according to claim 1, wherein in the first-polarity electrodes, a superposed width of regions where the insulating layers are formed is small as compared with a superposed width of ends of the lead sections as viewed in the lamination direction.

3. The laminated-type battery according to claim 1, wherein the first-polarity electrode has a notch portion in at least a part of the region where the insulating layer is formed.

4. The laminated-type battery according to claim 3, wherein the first-polarity electrodes have the notch portions, and the notch portions have two or more types of shapes.

5. The laminated-type battery according to claim 3, wherein when all the notch portions are superposed in the lamination direction of the battery element, the notch portions entirely cover active material layer-formed regions having the insulating layer formed before notching as viewed in the lamination direction.

6. The laminated-type battery according to claim 3, wherein the notch portion is provided in at least a part of a region where the insulating layer and the active material layer are formed.

7. The laminated-type battery according to claim 3, wherein the battery element further comprises the first-polarity electrode having no notch portion.

8. The laminated-type battery according to claim 1, wherein the insulating layer is at least one selected from the group consisting of adhesive tapes, heat fusing tapes, and layers formed by coating and drying a liquid comprising an insulating material.

9. The laminated-type battery according to claim 1, wherein the first-polarity electrode is a positive electrode, and the second-polarity electrode is a negative electrode.

10. The laminated-type battery according to claim 1, wherein the first-polarity electrode has a hole in at least a part of the region where the insulating layer is formed.

11. The laminated-type battery according to claim 1, comprising a battery element comprising at least three sheets of the first-polarity electrodes each laminated on the second-polarity electrode with the separator therebetween.

12. The laminated-type battery according to claim 1, wherein the second-polarity electrode is folded while the second-polarity electrode alternately interposes the first-polarity electrode and the separator therebetween.

13. The laminated-type battery according to claim 1, wherein the separator is folded while the separator alternately interposes the first-polarity electrode and the second-polarity electrode therebetween.

14. The laminated-type battery according to claim 1, wherein the laminated-type battery is a lithium ion secondary battery, a nickel hydrogen battery, a lithium ion capacitor, a nickel cadmium battery, a lithium metal primary battery, a lithium metal secondary battery or a lithium polymer battery.

15. The laminated-type battery according to claim 1, wherein the battery element comprises at least two sheets of the second-polarity electrodes,
wherein the second-polarity electrode comprises: an electrode section having an active material layer formed on a current collector; a lead section having no active material layer formed on the current collector; and an insulating layer disposed over from the active material layer to an active material layer-non-formed region on a boundary region of the electrode section and the lead section,
wherein the insulating layer of the one second-polarity electrode and the insulating layer of the another second-polarity electrode are formed at least partly on different positions as viewed in the lamination direction.

16. A laminated-type battery, comprising a battery element having at least two sheets of first-polarity electrodes each laminated on a second-polarity electrode with a separator therebetween,
wherein the first-polarity electrode comprises: an electrode section having an active material layer formed on a current collector; a lead section having no active material layer formed on the current collector; and an insulating layer disposed over from the active material layer to an active material layer-non-formed region on a boundary region of the electrode section and the lead section,
wherein the insulating layer of the one first-polarity electrode and the insulating layer of the another first-polarity electrode are formed at least partly on different positions as viewed in the lamination direction, and
wherein the formation of the insulating layers at least partly on the different positions reduces a thickness of a laminated portion of the insulating layers.

17. A method for manufacturing a laminated-type battery, comprising:
forming an active material layer on a surface of a current collector to thereby obtain an electrode comprising an electrode section having the active material layer formed on the current collector and a lead section having no active material layer formed on the current collector;
forming an insulating layer over from the active material layer to an active material layer-non-formed region on a boundary region of the electrode section and the lead section of the electrode to thereby obtain a first-polarity electrode;
notching at least a part of a region of the first-polarity electrode where the insulating layer is formed to thereby form a notch portion; and
laminating at least two sheets of the first-polarity electrodes each with a second-polarity electrode with a separator therebetween,
wherein the insulating layer of the one first-polarity electrode and the insulating layer of the another first-polarity electrode are formed at least partly on different positions as viewed in the lamination direction.
